(19) United States
(12) Patent Application Publication
(10) Pub. No.: US 2023/0042566 A1
(43) Pub. Date: Feb. 9, 2023

(54) BATTERY PACK HOUSING, BATTERY PACK, AND ELECTRIC VEHICLE

(71) Applicant: BYD COMPANY LIMITED, Shenzhen (CN)

(72) Inventors: Huajun SUN, Shenzhen (CN); Zhipei LU, Shenzhen (CN); Qingbo PENG, Shenzhen (CN); Long WAN, Shenzhen (CN); Yan ZHU, Shenzhen (CN)

(21) Appl. No.: 17/972,099

(22) Filed: Oct. 24, 2022

Related U.S. Application Data
(63) Continuation of application No. PCT/CN2020/128118, filed on Nov. 11, 2020.

(30) Foreign Application Priority Data
Apr. 24, 2020 (CN) 202020637729.0

(51) Int. Cl. H01M 50/244; H01M 50/249; B60L 50/60; B60L 50/64

(52) U.S. Cl. CPC H01M 50/244; H01M 50/249; B60L 50/66; B60L 50/64; H01M 2220/20

(57) ABSTRACT

The present disclosure provides a battery pack housing, a battery pack, and an electric vehicle. The battery pack housing includes a housing body and at least one structural beam disposed in the housing body. The at least one structural beam divides the internal space of the housing body into a number of accommodation cavities. The housing body includes a top plate and a bottom plate arranged opposite to each other in a first direction, the first direction is a height direction of the battery pack housing, and the structural beam is located between and attached to the top plate and the bottom plate. The battery pack housing comprises a mounting part for connecting mounting portion for a fixed connection with an external load. The battery pack housing disclosed in the present disclosure has relatively high strength and stiffness as well as high space utilization.

### CROSS-REFERENCE TO RELATED APPLICATIONS

This application is a continuation application of International Patent Application No. PCT/CN2020/128118 filed with the China National Intellectual Property Administration (CNIPA) on Nov. 11, 2020, which is based on and claims priority to and benefits of Chinese Patent Application No. 202020637729.0, filed on Apr. 24, 2020. The entire content of all of the above-referenced applications is incorporated herein by reference.

### FIELD

The present disclosure relates to the field of batteries, and more specifically, to a battery pack housing, a battery pack, and an electric vehicle.

### BACKGROUND

The design for conventional battery pack housings generally has too many parts, a complicated structure, and inefficient space utilization of the battery pack housing. The requirement of connecting the parts through welding leads to relatively high manufacturing costs. In addition, having too many welding joints of the battery pack housing causes a higher risk of failure in sealing the battery pack once a welding joint loses effectiveness, thereby impacting the service life of the battery pack.

### SUMMARY

A first aspect of the present disclosure provides a battery pack housing including a housing body and at least one structural beam disposed in the housing body. The at least one structural beam divides the internal space of the housing body into a number of accommodation cavities.

The housing body includes a top plate and a bottom plate arranged opposite to each other in a first direction, the first direction is a height direction of the battery pack housing, and the structural beam is located between and attached to the top plate and the bottom plate.

The battery pack housing includes a mounting portion for connecting with an external load.

In some embodiments of the present disclosure, the length of the accommodation cavities in a second direction is greater than 500 mm, and the second direction is a width direction or a length direction of the battery pack housing.

In some embodiments of the present disclosure, the battery pack housing includes a plurality of structural beams including the at least one structural beam, lengths of the structural beams extend in a second direction, the structural beams are spaced apart along a third direction, the structural beams are spaced apart along a third direction, and each of the structural beams is attached to the top plate and the bottom plate. The second direction is a length direction of the battery pack housing, and the third direction is a width direction of the battery pack housing; or, the second direction is a width direction of the battery pack housing, and the third direction is a length direction of the battery pack housing.

In some embodiments of the present disclosure, the housing body is integrally formed with the at least one structural beam.

In some embodiments of the present disclosure, the housing body further includes a first frame and a second frame on two sides of the housing body in a third direction, and the third direction is a width direction or a length direction of the battery pack housing.

In some embodiments of the present disclosure, at least one of the first frame and the second frame has a cavity, reinforcement plates are arranged in the cavity, and the reinforcement plates divide the cavity into a number of sub-cavities.

In some embodiments of the present disclosure, the mounting portion is arranged on at least one of the first frame and the second frame.

In some embodiments of the present disclosure, the battery pack housing further includes a first end plate, a first end of the housing body includes a first opening, and the first end plate covers the first opening.

In some embodiments of the present disclosure, battery pack housing further includes a second end plate, a second end of the housing body includes a second opening, and the second end plate covers the second opening.

In some embodiments of the present disclosure, the housing body is connected to the first end plate and the second end plate by welding such that the first end plate and the second end plate seal the first opening and the second opening, respectively, of the housing body.

In some embodiments of the present disclosure, the battery pack housing further includes a sealing plate, a third opening is arranged at ends of the accommodation cavities in the second direction, the sealing plate is disposed between the end plate and the housing body, and the sealing plate occludes at least a portion of the third opening adjacent to the bottom plate.

In some embodiments of the present disclosure, the sealing plate completely occludes the third opening.

In some embodiments of the present disclosure, a recess recessed away from the first end plate is arranged at an end of the at least one structural beam in the second direction.

In some embodiments of the present disclosure, the at least one structural beam includes a heat dissipation channel, the heat dissipation channel extends in a second direction, and the second direction is a width direction or a length direction of the battery pack housing.

In some embodiments of the present disclosure, the at least one structural beam includes a first side plate and a second side plate arranged at an interval in a third direction, the first side plate, the second side plate, the top plate, and the bottom plate define the heat dissipation channel, the second direction is a width direction of the battery pack housing, and the third direction is a length direction of the battery pack housing; or, the second direction is a length direction of the battery pack housing, and the third direction is a width direction of the battery pack housing.

In some embodiments of the present disclosure, the at least one structural beam further includes at least a partition plate connected to the first side plate and the second side plate, and the partition plate divides the heat dissipation channel into a number of sub-channels.

In some embodiments of the present disclosure, the battery pack housing includes at least an adhesive application hole, and each of the accommodation cavities communicates with a corresponding adhesive application hole of the at least one adhesive application hole.

In some embodiments of the present disclosure, the battery pack housing is a sealed housing, and an air pressure inside the accommodation cavities is lower than an air pressure outside the battery pack housing.

In some embodiments of the present disclosure, the pressure inside the accommodation cavities is −40 KPa to −70 KPa.

In some embodiments of the present disclosure, the battery pack housing is arranged with at least an exhaust orifice.

In some embodiments of the present disclosure, each of the accommodation cavities communicates with a corresponding exhaust orifice of the at least one exhaust orifice.

In some embodiments of the present disclosure, a number of the accommodation cavities are in a communication with each other.

A second aspect of the present disclosure provides a battery pack including the battery pack housing according to any one of above described.

A third aspect of the present disclosure provides an electric vehicle including an external load and the battery pack described above that is fixed to the external load.

Additional aspects and advantages of the present disclosure are partially provided in the following description, and partially become apparent in the following description or understood through the practice of the present disclosure.

### BRIEF DESCRIPTION OF THE DRAWINGS

FIG. 1 is a schematic diagram of a structure of a battery pack according to an embodiment of the present disclosure.

FIG. 2 is an exploded view of a battery pack housing according to an embodiment of the present disclosure.

FIG. 3 is a partial enlarged view of A shown in FIG. 2.

FIG. 4 is a partial enlarged view of B shown in FIG. 2.

FIG. 5 is a schematic diagram of a structure of an electric vehicle according to an embodiment of the present disclosure.

### NUMERALS

battery pack 100; battery pack housing 200; and electric vehicle 300;
housing body 10; top plate 101; bottom plate 102; first frame 103; first frame part 1031; second frame part 1032; second frame 104; third frame part 1041; fourth frame part 1042; reinforcement plate 105; sub-cavity 106; third frame 107; fourth frame 108; adhesive application hole 109; exhaust orifice 110; cavity 111; end plate 112; and first opening 113;
structural beam 20; recess 201; heat dissipation channel 202; first side plate 203; second side plate 204; and partition plate 205;
accommodation cavity 30; and
mounting portion 40; and mounting hole 401.

### DETAILED DESCRIPTION

Embodiments of the present disclosure are described in detail below, and examples of the embodiments are shown in accompanying drawings, where the same or similar elements or the elements having same or similar functions are denoted by the same or similar reference numerals throughout the description. The embodiments that are described with reference to the accompanying drawings are exemplary, and are only used to interpret the present disclosure, instead limiting the present disclosure.

In the description of the present disclosure, it should be understood that, orientations or position relationships indicated by terms such as “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “axial”, “radial”, and “circumferential” are orientations or position relationship shown based on the accompanying drawings, and are merely used for describing the present disclosure and simplifying the description, rather than indicating or implying that the apparatus or element should have a particular orientation or be constructed and operated in a particular orientation, and therefore, should not be construed as a limitation to the present disclosure.

Conventional battery pack housings generally include a bottom plate and a top plate, and the bottom plate typically includes a base plate welded to a number of side beams. In addition, as a main load-bearing component of a battery pack, the bottom plate is usually welded with a number of cross beams and longitudinal beams inside in the manufacturing process thereof to ensure strength of the bottom plate. As explained above, this leads to reliability issues.

Beneficial effects of the present disclosure is that, the battery pack housing disclosed in the present disclosure includes a structural beam between a top plate and a bottom plate, and the structural beam is attached to the top plate and the bottom plate. This arrangement of the structural beam, the top plate, and the bottom plate forms a “I”-shaped structure which has relatively high strength and stiffness, so that the requirements on load-bearing, impact resistance, crush resistance, etc. of the battery pack housing can be satisfied. In addition, the battery pack housing disclosed in the present disclosure relatively has a simple structure, low manufacturing costs, and high space utilization. Further, the structural beam divides the housing body into a number of accommodation cavities, so that when overheating occurs in a cell assembly or an individual cell in one of the accommodation cavities, the other accommodation cavities are not impacted, thereby improving the safety of using the battery pack. In addition, when such a battery pack is mounted on a vehicle, the structural strength of the battery pack can be taken as a part of the structural strength of the vehicle, so that the structural strength of the vehicle can be enhanced, which facilitates fulfilling the design requirement of a light-weight electric vehicle and reducing the costs of designing and manufacturing the electric vehicle.

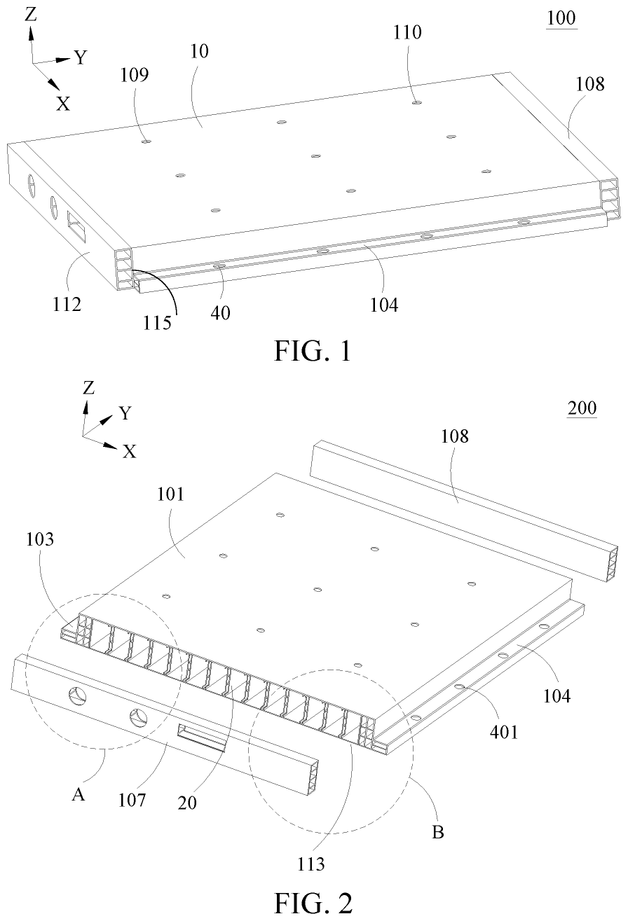

As shown in FIG. 1 to FIG. 3, the present disclosure provides a battery pack housing 200 including a housing body 10 and at least one structural beam 20 inside the housing body 10, and the at least one structural beam 20 divides the internal space of the housing body 10 into a number of accommodation cavities 30. The housing body 10 includes a top plate 101 and a bottom plate 102 arranged opposite to each other in a first direction, where the first direction is a height direction of the battery pack housing 200, the structural beam 20 locates between the top plate 101 and the bottom plate 102, and the at least one structural beam 20 is attached to the top plate 101 and the bottom plate 102. The battery pack housing 200 is arranged with a mounting portion 40 for a fixed connection with an external load. The first direction is the direction of a Z-axis in the figure.

The battery pack housing 200 disclosed in the present disclosure includes the structural beam 20 between the top plate 101 and the bottom plate 102, and the structural beam 20 is attached to the top plate 101 and the bottom plate 102. This arrangement of the structural beam 20, the top plate 101, and the bottom plate 102 forms a “I”-shaped structure which has relatively high strength and stiffness, so that the requirements of load-bearing, impact resistance, crush resistance, of the battery pack housing 200 can be satisfied. In addition, the battery pack housing 200 disclosed in the present disclosure has a simple structure, low manufacturing costs, and high space utilization. Further, the structural beam 20 divides the internal space of the housing body 10 into a number of the accommodation cavities 30, so that when overheating occurs in a cell assembly or an individual cell in one of the accommodation cavities 30, the other accommodation cavities 30 are not impacted, thereby improving the safety of using the battery pack 100. In addition, when such a battery pack 100 is mounted on a vehicle, the structural strength of the battery pack 100 can be taken as a part of the structural strength of the vehicle, so that the structural strength of the vehicle can be enhanced, which facilitates fulfilling the design requirement of a light-weight electric vehicle and reducing the costs of designing and manufacturing the electric vehicle.

It should be noted that the battery pack housing 200 disclosed in the present disclosure refers to a housing of the battery pack 100 for accommodating a cell assembly, an individual cell, or the like. Through the mounting portion 40 thereon, the battery pack housing 200 is fixed to an external load through a detachable or non-detachable connection, and does not refer to a battery case for a battery module or an individual cell. Generally, the battery pack 100 further includes at least one of a battery management system (BMS), a battery connector, a battery sampler, and a battery thermal management system.

The cell assembly includes an encapsulation film and at least one electrode core encapsulated by using the encapsulation film. The electrode core can be a commonly used electrode core in the field of traction batteries, an electrode core made by winding, or an electrode core made by stacking. Generally, the electrode core includes at least a positive plate, a membrane, and a negative plate.

In addition, the structural beam 20 being attached to the top plate 101 and the bottom plate 102 can be understood as that the top plate 101, the bottom plate 102, and the structural beam 20 are integrally formed as one piece. In an embodiment, one of the top plate 101 and the bottom plate 102 is integrally formed with the structural beam 20, and the other is welded to the structural beam 20. In another embodiment, one end of the structural beam 20 is welded to the bottom plate 102, and the other end of the structural beam 20 is welded to the top plate 101.

In one embodiment, as shown in FIG. 2, a length of the accommodation cavities 30 in a second direction is greater than 500 mm, such as 500 mm to 2,500 mm. The second direction is different from the first direction, and the second direction is the direction of a Y-axis in the figure. The size of the accommodation cavities 30 allows the battery pack 100 to meet the requirements for a relatively large capacity and relatively high space utilization.

According to some embodiments of the present disclosure, the length of the accommodation cavities 30 in the second direction is 1,000 mm to 2,000 mm.

According to some embodiments of the present disclosure, the length of the accommodation cavities 30 in the second direction is 1,300 mm to 2,200 mm.

In this embodiment, the second direction is a width direction or a length direction of the battery pack housing 200.

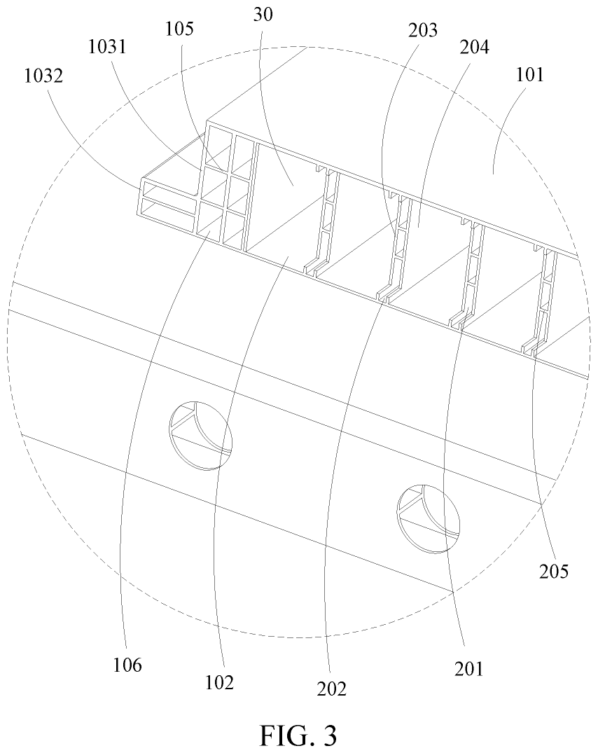

In one embodiment, as shown in FIG. 2 to FIG. 3, there are a number of structural beams 20, lengths of the structural beams 20 extend in a second direction, a number of the structural beams 20 are spaced apart along a third direction, and each of the structural beams 20 is attached to the top plate 101 and the bottom plate 102. The third direction is the direction of an X-axis in the figure.

In one embodiment, a housing body 10 and the structural beams 20 are integrally formed together as one piece. This arrangement not only allows a simple manufacturing process, which reduces the production costs, but also ensures sufficient structural strength and stiffness of the housing body, so as to meet the requirements of load-bearing, impact resistance and crush resistance of the housing body.

Specifically, the top plate 101, the bottom plate 102, and the structural beams 20 are integrally formed together as one piece.

In one embodiment, the second direction is a length direction of the battery pack housing 200, and the third direction is a width direction of the battery pack housing 200; or the second direction is a width direction of the battery pack housing 200, and the third direction is a length direction of the battery pack housing 200.

It can be understood that, as each of the structural beams 20 is attached to the top plate 101 and the bottom plate 102, each structural beam 20, the top plate 101, and the bottom plate 102 form a “I”-shaped structure which has relatively high strength and stiffness, so that the requirements of load-bearing, impact resistance, crush resistance, of the battery pack housing 200 can be satisfied. Moreover, the battery pack housing 200 has a simple structure and high space utilization. In addition, the housing body 10 and the structural beams 20 are integrally formed together as one piece, and the manufacturing thereof is simple, so that the production costs can be reduced. When such a battery pack 100 is mounted on a vehicle, the structural strength of the battery pack 100 can be taken as a part of the structural strength of the vehicle, so that the structural strength of the vehicle can be enhanced, which facilitates fulfilling the design requirement of a light-weight electric vehicle and reducing the costs of designing and manufacturing the electric vehicle.

In one embodiment, as shown in FIG. 2 to FIG. 4, the housing body 10 further includes a first frame 103 and a second frame 104 on two sides of the housing body 10 in a third direction, and the third direction is a width direction or a length direction of the battery pack housing 200, such as the direction of an X-axis in the figure.

In some embodiments, the housing body 10 includes a top plate 101 and a bottom plate 102 arranged opposite to each other in a first direction, and a first frame 103 and a second frame 104 arranged opposite to each other in a third direction. The top plate 101, the first frame 103, the bottom plate 102, and the second frame 104 are connected with each other.

It can be understood that the top plate 101, the first frame 103, the bottom plate 102, and the second frame 104 collectively define an accommodation space. The structural beams 20 are in the accommodation space. According to some embodiments of the present disclosure, the top plate 101, the first frame 103, the bottom plate 102, and the second frame 104 are integrally formed together as one piece, and this arrangement can ensure relatively high structural strength of the housing body 10 while the manufacturing is relatively simple, thereby reducing the production costs. In other embodiments, the first frame 103 and the second frame 104 may be connected to the top plate 101 and the bottom plate 102 through an intermediate plate. In an embodiment, one end of the first frame 103 is welded to the top plate 101, and the other end of the first frame 103 is welded to the bottom plate 102. Similarly, one end of the second frame 104 is welded to the top plate 101, and the other end of the second frame 104 is welded to the bottom plate 102.

In one embodiment of the present disclosure, the top plate 101, the first frame 103, the bottom plate 102, the second frame 104, and the structural beams 20 are integrally formed together as one piece, for example, formed by intruding and integrating a piece of aluminum material. This not only ensures the relatively high structural strength of the battery pack housing 200, but also simplifies the manufacturing to reduce the processing costs. In other embodiments, the top plate 101, the bottom plate 102, and the structural beams 20 are integrally formed together as one piece. Then, the first frame 103 is welded to the top plate 101 and the bottom plate 102, and the second frame 104 is welded to the top plate 101 and the bottom plate 102.

In some embodiments, the first direction is a height direction of the battery pack housing 200. The second direction is a width direction of the battery pack housing 200, and the third direction is a length direction of the battery pack housing 200; or the second direction is a length direction of the battery pack housing 200, and the third direction is a width direction of the battery pack housing 200.

In this embodiment of the present disclosure, the second direction may be a width direction of the battery pack housing 200 and is parallel to a width direction of an electric vehicle 300. The third direction may be a length direction of the battery pack housing 200 and is parallel to a length direction of the electric vehicle 300.

In other embodiments, the second direction may be parallel to the length direction of the electric vehicle 300, and the third direction may be parallel to the width direction of the electric vehicle 300.

According to some embodiments of the present disclosure, as shown in FIG. 2 to FIG. 4, at least one of the first frame 103 and the second frame 104 has a cavity 111 inside. Reinforcement plates 105 are arranged in the cavity 111, and the reinforcement plates 105 divide the cavity 111 into a number of sub-cavities 106. This arrangement can ensure that the first frame 103 and the second frame 104 have specific strength, which helps improve the strength of the battery pack 100 to resist being impacted or crushed.

In one embodiment, as shown in FIG. 1 and FIG. 2, the first frame 103 and the second frame 104 are arranged with a mounting portion 40 for a fixed connection with an external load. In other embodiments, the mounting portion 40 may be arranged on the top plate 101 or the bottom plate 102.

In one embodiment, as shown in FIG. 1 and FIG. 2, the mounting portion 40 is mounting holes 401 arranged on the first frame 103 and the second frame 104. The mounting holes 401 are used for fasteners (such as bolts or rivets) to pass through to fix the battery pack 100 to an external load.

In some embodiments, the mounting holes 401 on the first frame 103 penetrate through the first frame 103 in a first direction, and the mounting holes 401 on the second frame 104 penetrate through the second frame 104 in a first direction. However, an axial direction of the mounting holes 401 may be arranged at an angle, for example, 5 degrees or 10 degrees, relative to the first direction.

According to some embodiments of the present disclosure multiple mounting holes 401 may be arranged on the first frame 103 one by one along a length direction of the first frame 103. The length direction of the first frame 103 is parallel to the second direction.

Similarly, the mounting holes 401 on the second frame 104 are arranged one by one along a length direction of the second frame 104. The length direction of the second frame 104 is parallel to the second direction.

In another embodiment, the mounting portion 40 is rings arranged on the first frame 103 and the second frame 104. The rings are fixedly connected to an external load, to fixedly connect the battery pack 100 to the external load.

However, in another embodiment, the mounting portion 40 is mounting blocks arranged on the first frame 103 and the second frame 104. The mounting blocks are fixed to an external load by welding. Clearly, the mounting blocks may be fixed to the external load by using adhesive or by clamping.

In one embodiment, as shown in FIG. 2 to FIG. 4, the first frame 103 includes a first frame part 1031 and a second frame part 1032, and the second frame 104 includes a third frame part 1041 and a fourth frame part 1042. The first frame part 1031 and the third frame part 1041 are arranged opposite to each other in a second direction and are connected to the top plate 101 and the bottom plate 102. The second frame part 1032 is on the side of the first frame part 1031 facing away from the third frame part 1041, and the fourth frame part 1042 is on the side of the third frame part 1041 facing away from the first frame part 1031. The mounting portion 40 is arranged on the second frame part 1032 and the fourth frame part 1042.

According to some embodiments of the present disclosure, the first frame part 1031 is perpendicular to the second frame part 1032, forming an L-shaped structure. This arrangement enhances the structural strength of the first frame 103. The third frame part 1041 is perpendicular to the fourth frame part 1042, forming an L-shaped structure. This arrangement enhances the structural strength of the second frame 104. However, the first frame part 1031 and the second frame part 1032, as well as the third frame part 1041 and the fourth frame part 1042 may be arranged with another angle, for example, 70 degrees or 80 degrees.

In one embodiment, as shown in the figure, the battery pack housing 200 further includes an end plate 112, a first opening 113 is arranged at an end of the housing body 10 in a second direction, the end plate 112 covers/seals the first opening 113, and the second direction is a width direction or a length direction of the battery pack housing 200.

It can be understood that a cell assembly or an individual cell may be mounted inside the accommodation cavities 30 through the first opening 113, for an easy operation. In addition, electrodes of the cell assembly or individual cell inside the accommodation cavities 30 can be led out through the first opening 113 while ensuring relatively high structural strength of the battery pack housing 200.

According to some embodiments of the present disclosure, the first openings 113 may be arranged in the second direction at both ends of the housing body 10. The end plate 112 includes a third frame 107 and a fourth frame 108. The third frame 107 and the fourth frame 108 are connected to the housing body 10 to cover/seal the corresponding first opening 113.

It can be understood that when the first openings 113 are arranged in the second direction at both ends of the housing body 10, the electrodes of the cell assembly or the individual cell inside the accommodation cavities 30 can be led out through the two first openings 113 respectively.

According to some embodiments of the present disclosure, the housing body 10, the third frame 107, and the fourth frame 108 may be made of metals and be connected or sealed together by welding.

However, in other embodiments, the housing body 10, the third frame 107, and the fourth frame 108 may be made of plastic. In addition, the third frame 107 and the fourth frame 108 may be connected to or sealed with the housing body 10 by using adhesive or by clamping.

According to some embodiments of the present disclosure, as shown in FIG. 2 to FIG. 4, the third frame 107 and the fourth frame 108 are hollow inside. Reinforcement plates 105 are arranged in the third frame 107 and the fourth frame 108, and the reinforcement plates 105 divide the internal spaces of the third frame 107 and the fourth frame 108 into a number of sub-cavities 106. This arrangement can ensure that the third frame 107 and the fourth frame 108 have specific strength, which improves the strength of the battery pack housing 200 to resist impacts or crushes.

In one embodiment, the battery pack housing 200 further includes a sealing plate 115 as shown in FIG. 1, a second opening is arranged at an end of the accommodation cavities 30 in the second direction, where the sealing plate 115 is arranged on an inner side of the end plate 112. The sealing plate 115 is connected to the structural beams 20 and the housing body 10 to block off at least a portion of the second opening of the accommodation cavities 30 that is adjacent to the bottom plate 102. To be specific, the second opening of the accommodation cavities 30 is half blocked by using the sealing plate 115. When the accommodation cavities 30 accommodate an electrode core assembly encapsulated by using an encapsulation film, unexpected breakage of the encapsulation film may cause a flow of electrolyte from one accommodation cavity 30 to another accommodation cavity 30 which leads to an internal short circuit. The sealing plate 115 may prevent the internal short circuit, thereby improving the safety of using the battery pack 100.

The half blockage of the second opening of the accommodation cavities 30 at both ends of the accommodation cavities 30 may be formed by connecting the sealing plate, the first frame 103, the bottom plate 102, and the structural beams 20, or by connecting the sealing plate, the second frame 104, the bottom plate 102, and the structural beams 20, to block a portion of the second opening of the accommodation cavities 30 adjacent to the bottom plate 102.

The half blockage of the second opening of other accommodation cavities 30 in the middle of the accommodation cavities 30 may be formed by connecting the sealing plate, the bottom plate 102, and two adjacent structural beams 20, to block a portion of the second opening of the accommodation cavities 30 adjacent to the bottom plate 102.

In one embodiment, as shown in the figure, the battery pack housing 200 further includes a sealing plate, a second opening is arranged at an end of the accommodation cavities 30 in the second direction, where the sealing plate is arranged at an inner side of the end plate 112. The sealing plate is connected to the structural beams 20 and the housing body 10 to completely block the second opening of the accommodation cavities 30. That is, the second opening of the accommodation cavities 30 is completely blocked by using the sealing plate, so that the safety of using the battery pack 100 is improved.

The complete blockage of the second opening of the accommodation cavities 30 at both ends of the accommodation cavities 30 may be formed by connecting the sealing plate, the first frame 103, the structural beams 20, the top plate 101, and the bottom plate 102, or by connecting the sealing plate, the second frame 104, the structural beams 20, the top plate 101, and the bottom plate 102, to completely block the second opening of the accommodation cavities 30.

The complete blockage of the second opening of other accommodation cavities 30 in the middle of the accommodation cavities 30 may be formed by connecting the sealing plate, the bottom plate 102, the top plate 101, and two adjacent structural beams 20, to completely block the second opening of the accommodation cavities 30.

In one embodiment, as shown in FIG. 1 and FIG. 2, a recess 201 recessed away from the end plate 112 is arranged at an end of the at least one structural beam 20 in the second direction.

The structural design of the recess 201 can be used for accommodating an insulation protection frame, an electrical connector, etc. This structural design does not increase the length of the battery pack housing 200 in the second direction, which reduces the size of the battery pack housing 200.

According to some embodiments of the present disclosure, the recess 201 is arranged at either end of each structural beam 20 in the second direction, where the recesses 201 adjacent to the third frame 107 draw back from the third frame 107, and the recesses 201 adjacent to the fourth frame 108 draw back from the fourth frame 108.

In one embodiment, as shown in FIG. 2 to FIG. 4, a heat dissipation channel 202 is arranged in the at least one structural beam 20. The heat dissipation channel 202 extends in a second direction, and the second direction is a width direction or a length direction of the battery pack housing 200. In this way, the heat from the cell assembly or the individual cell accommodated in the accommodation cavities 30 can be transferred to the outside of the battery pack housing 200 via the top plate 101 and the bottom plate 102 through the heat dissipation channel 202. This structural design in the present disclosure provides a larger heat dissipation space inside the battery pack housing 200 when compared with a solid-structure design of the structural beam 20, thereby improving the cooling and heat dissipation effects.

In one embodiment, as shown in FIG. 2 to FIG. 4, each structural beam 20 includes a first side plate 203 and a second side plate 204 arranged at an interval in a third direction. The first side plate 203, the second side plate 204, the top plate 101, and the bottom plate 102 collectively define the heat dissipation channel 202. The second direction is a width direction of the battery pack housing 200, and the third direction is a length direction of the battery pack housing 200; or, the second direction is a length direction of the battery pack housing 200, and the third direction is a width direction of the battery pack housing 200.

That is, the space surrounded by the first side plate 203, the second side plate 204, the top plate 101, and the bottom plate 102 is the heat dissipation channel 202. In this way, the heat dissipation channel 202 can be formed simply by utilizing the structure of the housing body 10 and the structural beam 20 without an additional heat dissipation pipe, thereby simplifying the structural design of the battery pack 100 and reducing the production costs.

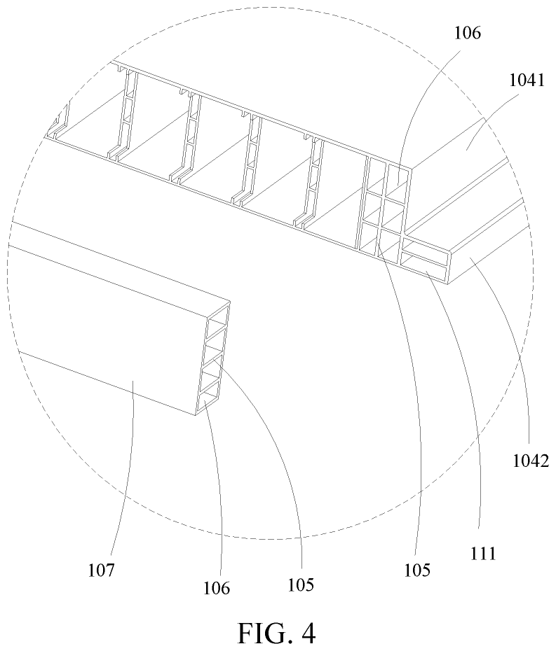

In one embodiment, as shown in FIG. 2 and FIG. 4, the structural beam 20 further includes a partition plate 205 connected to both the first side plate 203 and the second side plate 204, and the partition plate 205 divides the heat dissipation channel 202 into a number of sub-channels. This arrangement can achieve better cooling and heat dissipation effects of the battery pack housing 200, and at the same time can ensure specific strength of the structural beam 20, thereby improving the overall strength of the battery pack 100.

In one embodiment, as shown in FIG. 1 and FIG. 2, the battery pack housing 200 is arranged with at least an adhesive application hole 109, and each of the accommodation cavities 30 is in a corresponding communication with the at least one adhesive application hole 109. It can be understood that a structural adhesive can be injected into the battery pack housing 200 through the adhesive application hole 109 to fixedly connect the cell assembly or the individual cell accommodated in the accommodation cavities 30 to the battery pack housing 200, thereby improving the structural strength of the battery pack 100.

In one embodiment, the battery pack housing 200 is a sealed housing, and an air pressure inside the accommodation cavities 30 is lower than an air pressure outside the battery pack housing 200. This arrangement allows a vacuuming operation to get the air pressure inside the accommodation cavities 30 lower than the air pressure outside the battery pack housing 200, which can reduce the amount of substances (e.g., water vapor) inside the battery pack housing 200, so as to prevent aging, damage, etc. of a component (e.g., the cell assembly or the cell) inside the battery pack housing 200 due to a long-term effect of the water vapor, thereby prolonging the service life of the battery pack 100. In addition, the sealed housing may further function as a double seal.

In one embodiment, the pressure inside the accommodation cavities 30 is −40 KPa to −70 KPa. This arrangement can ensure that the amount of substances such as water vapor and oxygen inside the battery pack housing 200 is reduced, so as to prevent aging of the cell assembly or various other components inside the battery pack housing 200 due to a long-term effect of the water vapor and oxygen, thereby prolonging the service life of the cell assembly or various other components inside the battery pack housing 200.

In one embodiment, as shown in FIG. 1 and FIG. 2, the battery pack housing 200 is arranged with at least an exhaust orifice 110. Vacuuming the inside of the battery pack housing 200 through the exhaust orifice 110 can reduce the amount of substances such as water vapor inside the battery pack housing 200, so as to prevent aging, damage, etc. of a component, such as the cell assembly or the cell, inside the battery pack housing 200 due to a long-term effect of the water vapor, thereby prolonging the service life of the battery pack 100.

In one embodiment, as shown in FIG. 1 and FIG. 2, the battery pack housing 200 is arranged with a number of exhaust orifices 110, and a number of the exhaust orifices 110 are in communications with a number of the accommodation cavities 30, respectively. This arrangement enhances the efficiency of the vacuuming operation and reduces the production costs.

In one embodiment, as shown in FIG. 1 and FIG. 2, a number of the accommodation cavities 30 are in communications with each other, and the battery pack housing 200 is arranged with at least one exhaust orifice 110 that is in a communication with the accommodation cavities 30. In this way, the number of the accommodation cavities 30 can be vacuumed at the same time through the at least one exhaust orifice 110.

It should be noted that a type of the communication with the accommodation cavities 30 is not specifically limited. For example, the accommodation cavities 30 may achieve the communication through the first opening 113 at the end. In an embodiment, the structural beam 20 is arranged with a through hole that communicates two adjacent accommodation cavities 30.

According to some embodiments of the present disclosure, as shown in FIG. 1, the top plate 101 is arranged with the adhesive application hole 109, the exhaust orifice 110, or the adhesive application hole 109 and the exhaust orifice 110. However, in other embodiments, the bottom plate 102, the first frame 103, or the second frame 104 may be arranged with the adhesive application hole 109, or the exhaust orifice 110, or the adhesive application hole 109 and the exhaust orifice 110.

Further, a manner of sealing the exhaust orifice 110 is not specifically limited. For example, the exhaust orifice 110 may be sealed by a sealing member or may be sealed by using a potting adhesive.

It should be noted that the adhesive application hole 109 and the exhaust orifice 110 may be the same hole or different holes. In the case that the two holes are the same holes, a potting adhesive may be used and then vacuuming is performed.

Another aspect of the present disclosure provides a battery pack 100 including the battery pack housing 200 described above. The battery pack 100 provided in the present disclosure has relatively high structural strength and stiffness, relatively high space utilization, as well as relatively high safety of usage.

In still another aspect, the present disclosure further provides an electric vehicle 300 including a vehicle body and the battery pack 100 described above, and the battery pack 100 is fixed to the vehicle body through the mounting portion 40.

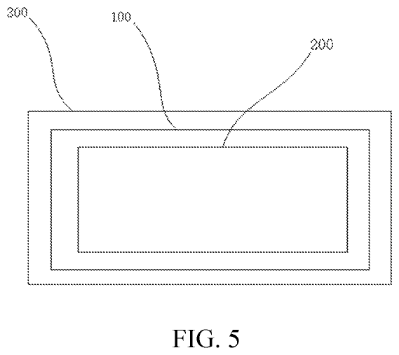

According to the electric vehicle 300 (see FIG. 5) provided in the present disclosure, when the battery pack 100 having relatively high strength is mounted on a vehicle, the structural strength of the battery pack 100 can be taken as a part of the structural strength of the vehicle, so that the structural strength of the vehicle can be enhanced, which facilitates fulfilling the design requirement of a light-weight electric vehicle and reducing the costs of designing and manufacturing the electric vehicle.

In the description of the present disclosure, it should be noted that unless otherwise explicitly specified or defined, the terms such as “mount”, “install”, “connect”, and “connection” should be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. A person of ordinary skill in the art may understand the specific meanings of the foregoing terms in the present disclosure according to specific situations.

In description of this specification, description of reference terms such as “an embodiment”, “specific embodiments”, or “an example”, means including specific features, structures, materials, or features described in this embodiment or example in at least one embodiment or example of the present disclosure. In this specification, schematic descriptions of the foregoing terms do not necessarily point at a same embodiment or example. Moreover, the specific features, structures, materials, or characteristics described may be combined in any one or more embodiments or examples in an appropriate manner.

Although the embodiments of the present disclosure have been shown and described, persons of ordinary skill in the art should understand that various changes, modifications, replacements and variations may be made to the embodiments without departing from the principles and spirit of the present disclosure, and the scope of the present disclosure is as defined by the appended claims and their equivalents.

What is claimed is:

1. A battery pack housing, comprising a housing body and at least one structural beam disposed in the housing body, wherein
the at least one structural beam divides an internal space of the housing body into a plurality of accommodation cavities;
the housing body comprises a top plate and a bottom plate arranged opposite to each other in a first direction, the first direction is a height direction of the battery pack housing, the at least one structural beam is located between and attached to the top plate and the bottom plate; and
the battery pack housing comprises a mounting portion for connecting with an external load.

2. The battery pack housing according to claim 1, wherein a length of the accommodation cavities in a second direction is greater than 500 mm, and the second direction is a width direction or a length direction of the battery pack housing.

3. The battery pack housing according to claim 1, wherein
the battery pack housing comprises a plurality of structural beams including the at least one structural beam,
lengths of the structural beams extend in a second direction, the structural beams are spaced apart along a third direction,
each of the structural beams is attached to the top plate and the bottom plate, and
the second direction is a length direction of the battery pack housing, and the third direction is a width direction of the battery pack housing; or, the second direction is a width direction of the battery pack housing, and the third direction is a length direction of the battery pack housing.

4. The battery pack housing according to claim 1, wherein the housing body is integrally formed with the at least one structural beam.

5. The battery pack housing according to claim 1, wherein the housing body comprises a first frame and a second frame on two sides of the housing body in a third direction, and the third direction is a width direction or a length direction of the battery pack housing.

6. The battery pack housing according to claim 5, wherein at least one of the first frame and the second frame has a cavity, reinforcement plates are arranged in the cavity, and the reinforcement plates divide the cavity into a plurality of sub-cavities.

7. The battery pack housing according to claim 5, wherein the mounting portion is arranged on at least one of the first frame and the second frame.

8. The battery pack housing according to claim 5, further comprising a first end plate, wherein a first end of the housing body comprises a first opening, and the first end plate covers the first opening.

9. The battery pack housing according to claim 8, further comprising a second end plate, wherein a second end of the housing body comprises a second opening, and the second end plate covers the second opening, wherein the housing body is connected to the first end plate and the second end plate by welding such that the first end plate and the second end plate seal the first opening and the second opening, respectively, of the housing body.

10. The battery pack housing according to claim 8, further comprising a sealing plate, wherein a third opening is arranged at ends of the accommodation cavities in the second direction, the sealing plate is disposed between the end plate and the housing body, and the sealing plate occludes at least a portion of the third opening adjacent to the bottom plate or the sealing plate completely occludes the third opening.

11. The battery pack housing according to claim 8, wherein a recess recessed away from the first end plate is arranged at an end of the at least one structural beam in the second direction.

12. The battery pack housing according to claim 1, wherein the at least one structural beam comprises a heat dissipation channel, the heat dissipation channel extends in a second direction, and the second direction is a width direction or a length direction of the battery pack housing.

13. The battery pack housing according to claim 12, wherein
the at least one structural beam comprises a first side plate and a second side plate arranged at an interval in a third direction,
the first side plate, the second side plate, the top plate, and the bottom plate define the heat dissipation channel, and
the second direction is a width direction of the battery pack housing, and the third direction is a length direction of the battery pack housing; or, the second direction is a length direction of the battery pack housing, and the third direction is a width direction of the battery pack housing.

14. The battery pack housing according to claim 13, wherein the at least one structural beam further comprises at least a partition plate connected to the first side plate and the second side plate, and the partition plate divides the heat dissipation channel into a plurality of sub-channels.

15. The battery pack housing according to claim 1, further comprising at least one adhesive application hole, wherein each of the accommodation cavities communicates with a corresponding adhesive application hole of the at least one adhesive application hole.

16. The battery pack housing according to claim 1, wherein the battery pack housing is a sealed housing, and an air pressure inside the accommodation cavities is lower than an air pressure outside the battery pack housing.

17. The battery pack housing according to claim 16, wherein the pressure inside the accommodation cavities is −40 KPa to −70 KPa.

18. The battery pack housing according to claim 16, further comprising at least one exhaust orifice, wherein each of the accommodation cavities communicates with a corresponding exhaust orifice of the at least one exhaust orifice.

19. The battery pack housing according to claim 18, wherein the accommodation cavities are in a communication with each other.

20. A battery pack, comprising a battery pack housing comprising a housing body and at least one structural beam inside the housing body, wherein
the at least one structural beam divides an internal space of the housing body into a plurality of accommodation cavities;
the housing body comprises a top plate and a bottom plate arranged opposite to each other in a first direction, the first direction is a height direction of the battery pack housing, the at least one structural beam is located between and attached to the top plate and the bottom plate; and
the battery pack housing comprises a mounting part for connecting with an external load.

21. An electric vehicle, comprising a vehicle body and a battery pack, wherein
the battery pack comprises a battery pack housing comprising a housing body and at least one structural beam inside the housing body;
the at least one structural beam divides an internal space of the housing body into a plurality of accommodation cavities;
the housing body comprises a top plate and a bottom plate arranged opposite to each other in a first direction, the first direction is a height direction of the battery pack housing, the at least one structural beam is located between and attached to the top plate and the bottom plate;
the battery pack housing comprises a mounting part for connecting with an external load; and
the battery pack is fixed to the vehicle body through the mounting portion.
